(19) United States
(12) Patent Application Publication
(10) Pub. No.: US 2014/0066561 A1
(43) Pub. Date: Mar. 6, 2014

(54) POLYAMIDE MOULDING COMPOUNDS AND THEIR APPLICATION

(71) Applicants: Mark PFLEGHAR, Domat/Ems (CH); Georg STOPPELMANN, Bonaduz (CH); Philipp HARDER, Chur (CH); Nikolai LAMBERTS, Bonaduz (CH)

(72) Inventors: Mark PFLEGHAR, Domat/Ems (CH); Georg STOPPELMANN, Bonaduz (CH); Philipp HARDER, Chur (CH); Nikolai LAMBERTS, Bonaduz (CH)

(73) Assignee: EMS-PATENT AG, Domat/Ems (CH)

(21) Appl. No.: 13/968,058

(22) Filed: Aug. 15, 2013

(30) Foreign Application Priority Data
Aug. 28, 2012 (EP) 12 182 022.9

(51) Int. Cl. C08K 7/14; C08K 3/26; C08K 3/30; C08L 77/00; C08K 3/22

(52) U.S. Cl. CPC C08K 7/14; C08L 77/00; C08K 3/22; C08K 3/30; C08K 3/26
USPC 524/407; 524/538; 524/606; 524/492; 524/420; 524/425

(57) ABSTRACT

This invention describes a thermoplastic moulding compound, specifically a polyamide moulding compound, consisting of:
(A) 20-88% by weight thermoplastic synthetic, preferably polyamide;
(B) 10-70% by weight fibre-shaped aggregates;
(B1) 10-70% by weight glass fibres that consist primarily of silicon dioxide, aluminium oxide, and magnesium oxide;
(B2) 0-20% by weight glass fibres that differ from the fibres in components (B1);
(B3) 0-20% by weight additional fibre-shaped aggregates that differ from the fibres in components (B1) and (B2), are not based on glass, and are selected from the following group: carbon fibres, graphite fibres, aramide fibres, nanotubes;
(C) 2-40% by weight particulate filler material;
(D) 0-2% by weight additives;
whereby the sum of (A) through (D) equals 100% weight.

### TECHNICAL FIELD

The present invention relates to strengthened thermoplastic moulding compounds made using glass fibres and particulate filler materials, in particular polyamide moulding compounds and components made thereof. Specifically the invention relates to thermoplastic moulding compounds, especially polyamide moulding compounds with improved mechanical characteristics. This is attained through a combination of thermoplastic synthetics, especially polyamide, particulate filler materials and high-strength glass fibres comprised of silicon dioxide, aluminium oxide, and magnesium oxide. The moulding compounds invented here will be used for manufacturing moulds/components and semi-finished as well as finished products.

### STATE OF THE ART

Polyamides are widely used as structural elements in indoor and outdoor applications due primarily to their outstanding mechanical characteristics.

An improvement in these mechanical characteristics, such as strength and stiffness, can be attained in particular by the addition of fibre-shaped reinforced materials, such as glass fibres. In many cases, particulate materials are used along with glass fibres, whether to colour moulding compounds by using inorganic pigments or to perform other specific modifications of characteristics.

Adding particulate filler material to glass fibre reinforced moulding compounds, however, often significantly impairs mechanical characteristics, in particular reducing tensile strength, ultimate elongation, and impact resistance. This results in a state that allows no or little particulate filler material content to be connected to the glass fibres if tensile strength and impact resistance are viewed as critical parameters for the moulded part. On the one hand, the addition of particulate filler material to glass fibre reinforced moulding compounds results in the desired pigmentation or functionality, yet on the other hand, this leads to deterioration in terms of mechanical characteristics such as tensile strength and impact resistance.

So-called E-glass fibres with a circular cross section are used almost exclusively when reinforcing polyamide moulding compounds with glass fibres. In accordance with ASTM D578-00, E-glass fibres consist of 52-62% silicon dioxide, 12-16% aluminium oxide, 16-25% calcium oxide, 0-10% borax, 0-5% magnesium oxide, 0-2% alkali oxides, 0-1.5% titanium dioxide, and 0-0.3% ferric oxide. E-glass fibres have a density of 2.54-2.62 g/cm3, a tensile modulus of 70-75 GPa, a tensile strength of 3000-3500 MPa, and an ultimate elongation of 4.5-4.8%, whereby the mechanical characteristics of individual fibres include a diameter of 10 μm and a length of 12.7 mm measured at 23° C. with a relative humidity of 50%.

If higher demands are placed on the mechanical characteristics, especially impact resistance or transverse strength or warping, E-glass fibres with a non-circular cross section, so-called flat glass fibres, offer a possible solution. Flat glass fibres with a 2:4 axial ratio of the cross-sectional axes exist. It must be expected that further optimisation of the cross-sectional geometry of this axial ratio can achieve only a slight improvement in mechanical characteristics and warping.

### DESCRIPTION OF THE INVENTION

One of the purposes of the present invention is to provide strengthened thermoplastic moulding compounds made using glass fibres and particulate filler materials, in particular polyamide moulding compounds and components made thereof.

This task is achieved by moulding compounds in accordance with claim 1 as well as components manufactured on the basis of such moulding compounds.

If we consider glass fibres with equal transverse cross-sectional area and diameter, then improvements can only be attained by a different composition of the raw glass material that improves the strength, tensile properties, and stiffness of the glass filaments. One such example would be S-glass fibres, which are currently used almost exclusively in the form of rovings (continuous filaments) for military applications and are superior to E-glass fibres in terms of glass filament characteristics. According to the ASM Handbook, Vol. 21: Composites (#06781G), in comparison to E-glass fibres, S-glass fibres show 12% higher stiffness, 25% higher tensile strength, and 20% higher ultimate elongation. Experiments with polyamide moulding compounds reinforced with S-glass fibres show, however, that the advantages of these glass fibres cannot be transferred, or can be transferred to a very limited extent, to glass fibre reinforced polyamide moulding compounds, even if the sizing was optimised for these moulding compounds. In many compounds that do not contain any particulate filler material, E-glass fibre with a round or flat cross section is superior even to high-performance S-glass fibre. Surprisingly, it has been shown that it is possible to prepare polyamide moulding compounds that contain both glass fibres and particulate filler material that enable the manufacture of moulds with good mechanical characteristics, especially high stiffness, high tensile strength, and good impact resistance, all without having the previously described disadvantages that mark the state of the art.

Specifically, the present invention relates to a moulding compound based primarily on polyamide with high stiffness, tensile strength, and impact resistance consisting of:
(A) 20-88% thermoplastic synthetic (by weight). This thermoplastic component (A) is preferably fabricated out of polyamide (A1) with the stipulation that up to 40%, though ideally only up to 20%, 10% or 5%, or in the range of 3-20% or 5-20% (as related to the proportional weight of total components (A) in the moulding compound), of the polyamide (A1) may be replaced by a thermoplastic synthetic (A2) that is not polyamide-based;
(B) 10-70% by weight of fibre-shaped additives, consisting exclusively of the following components (B1), (B2) and (B3);
   (B1) 10-70% by weight of high-strength glass fibres that consist primarily of silicon dioxide, aluminium oxide, and magnesium oxide, preferably with magnesium oxide content of at least 5% by weight and calcium oxide content of at most 10% by weight, though it is especially preferred that the latter does not exceed 5% by weight, or mixtures thereof;
   (B2) 0-20% by weight of glass fibres other than those of the components (B1); different glass fibres, preferably those that are made primarily of silicon dioxide, calcium oxide, and aluminium oxide, with a preferred weight ratio of SiO₂/(CaO+MgO) of less than 2.7, still more preferably one less than 2.5, and particularly preferably between 2.1 and 2.4;
   (B3) 0-20% by weight of additional fibre-shaped aggregates that differ from the fibres in components (B1) and (B2), preferably selected from the following group: carbon fibres, graphite fibres, aramide fibres, nanotubes;
(C) 2-40% by weight particulate filler material;
(D) 0-2% by weight additives;
whereby the sum of (A) through (D) equals 100% weight.

Component (A) is preferably a thermoplastic synthetic selected from the following group: polyamide, polycarbonate, polystyrene, polymethyl methacrylate, acrylonitrile-butadiene-styrene copolymer, acrylonitrile-styrene copolymer, polyolefin, polyoxymethylene, polyester, especially polyethylene terephthalate, polybutylene terephthalate, polysulphone (especially type PSU, PESU, PPSU), polyphenylene ether, polyphenylsulphone, polyphenylene oxide, liquid crystalline polymers, polyether ketone, polyether ether ketone, polyimide, polyamide-imide, polyester imide, polyetheramide, polyesteramide, polyether ester amide, polyurethane (especially type TPU, PUR), polysiloxane, polyacrylate, polymethyl acrylate, as well as mixtures or copolymers based on such systems. Such systems can also be implemented preferably in combination with the impact resistance modifiers identified and discussed under (A2).

The preferential proportion of component (A) should be 25-82% by weight, particularly in a range of 30-77% by weight.

The preferential proportion of component (B1) should be 15-65% by weight, particularly in a range of 20-60% by weight.

The preferential proportion of component (C) should be 3-25% by weight, particularly in a range of 3-15% by weight.

As explained, the moulding compound, with respect to its component (A), preferably consists primarily of polyamide in relation to the plastics matrix, or more concretely put, the preferred quantity is one greater than 60%. In other words, the ratio of (A1) to (A2) is preferred in any case to be >1.5, preferably >2, and ideally >5. The other thermoplastic synthetic (component A2), which can also take the form of a mixture of polyamide components (A1), is preferably selected from the group consisting of: polycarbonate, polystyrene, polymethyl methacrylate, acrylonitrile-butadiene-styrene copolymer, acrylonitrile-styrene copolymer, polyolefin, polyoxymethylene, polyester, especially polyethylene terephthalate, polybutylene terephthalate, polysulphone (especially type PSU, PESU, PPSU), polyphenylene ether, polyphenylsulphone, polyphenylene oxide, liquid crystalline polymers, polyether ketone, polyether ether ketone, polyimide, polyamide-imide, polyester imide, polyetheramide, polyesteramide, polyether ester amide, polyurethane (especially type TPU, PUR), polysiloxane, polyacrylate, polymethyl acrylate, as well as mixtures or copolymers based on such systems.

In another embodiment, the invented moulding compound contains up to 40% by weight of one or several impact resistance modifiers (IRM) as component (A2).

An IRM concentration of between 5% and 40% by weight, ideally 7-30% by weight, is preferred. The impact resistance modifier can be natural rubber, polybutadiene, polyisoprene, polyisobutylene, a mixed polymer of butadiene and/or isoprenes with styrol or styrol derivatives and other co-monomers, or an hydrogenated mixed polymer or a mixed polymer created by grafting or copolymerisation with acid anhydrides, (meth-)acrylic acids, or their esters. The impact resistance modifier (A2) can also consist of a grafted rubber with a cross-linked elastomer core comprised of butadiene, isoprene or alkyl acrylates and can have a graft envelope made of polystyrene, a nonpolar or polar olefin homo-/copolymer such as ethylene-propylene, ethylene-propylene-diene and ethylene-octene- or ethylene-vinyl-acetate rubber or a nonpolar or polar olefin homo-/copolymer created by grafting or copolymerisation with acid anhydrides, (meth-)acrylic acids, or their esters. The impact resistance modifier (A2) can also be a carboxylic-acid-functionalised copolymer such as poly(ethylene-co-(meth)acrylic acid) or poly(ethylene-co-1-olefin-co-(meth)acrylic acid), whereby the 1-olefin can be an alkene or a non-saturated (meth)acrylic acid ester with more than 4 atoms, including those copolymers in which acid groups are partially neutralised with metal ions.

Preferred impact resistance modifiers of component (A2) on the basis of styrol monomers (styrene and styrene derivatives) and other vinyl aromatic monomers are block copolymers built of alkenyl aromatic compounds or a conjugated diene, as well as hydrogenated block copolymers built of an alkenyl aromatic compound and conjugated dienes or combinations of these IRM types. The block copolymer contains at least one block derived from an alkenyl aromatic compound (A) and at least one block derived from a conjugated diene (B).

The proportion of aliphatic non-saturated carbon-carbon double bonds was reduced via hydrogenation. Two-, three-, four- and poly-block copolymers with a linear structure are suitable as block copolymers. Branched and radial structures, however, can also be used.

The typical method is used for creating branched block copolymers, for example through a grafting reaction of “side branch” polymers to a main polymer chain. Vinyl aromatic monomers that are substituted on the aromatic ring and/or on the C═C double bond with C1-20 hydrocarbon residue or halogen atoms can also be used as alkenyl aromatic monomers along with or in a compound with styrene.

Examples of alkenyl aromatic monomers are styrene, p-methylstyrene (α-methylstyrene, ethyl styrene, tertiary butyl styrene, vinyl toluene, 1,2-diphenyl ethylene, 1,1-diphenyl ethylene, vinyl xylene, vinyl toluenes, vinyl napthalene, divinyl benzenes, bromine styrenes, chlorine styrenes, as well as combinations thereof. Styrene, p-methylstyrene, alpha-methylstyrene, and vinyl napthalene are preferred.

Use of styrene, α-methylstyrene, p-methylstyrene, ethyl styrene, tertiary butyl styrene, vinyl toluene, 1,2-diphenyl ethylene, 1,1-diphenyl ethylene or their compounds is preferred. Styrene is particularly preferred. Alkenyl naphthalene can also be used, however.

The following diene monomers are suitable: 1,3-butadiene, 2-methyl-1,3-butadiene, 2,3-dimethyl-1,3-butadiene, 1,3-pentadiene, 1,3-hexadiene, isoprene, chloroprene and piperylene. 1,3-butadiene and isoprene are preferred, especially 1,3-butadiene (hereafter referred to as butadiene).

The preferred alkenyl aromatic monomer is styrene with butadiene as a diene monomer, meaning that the styrene-butadiene block copolymer is preferred. Block polymers are typically created via anionic polymerisation in a familiar method.

Furthermore, one can also use co-monomers in addition to styrene and diene monomers. The proportion of co-monomers is preferably 0-50%, even more preferably 0-30%, and ideally 0-15% by weight in relation to the total amount of monomers used. Suitable co-monomers are, for example, acrylates, especially C1-12-alkyl acrylates such as n-butyl acrylate or 2 ethylhexyl acrylate, and the corresponding methacrylates, especially C1-12-alkyl methacrylates such as methyl methacrylate (MMA).

Other possible co-monomers are (meth)acrylonitrile, glycidl(meth)acrylate, vinyl methylether, diallyl- and divinyl ether of bifunctional alcohols, divinyl benzene, and vinyl acetate.

In addition to a conjugate diene, hydrogenated block copolymers of component (A2) contain, if necessary, portions of lower hydrocarbons such as ethylene, propylene, 1-butylene, dicyclopentadiene, or non-conjugate dienes. The proportion of non-reduced aliphatic non-saturated bonds that result from Block B in the hydrogenated block copolymers is less than 50%, preferably less than 25%, and ideally less than 10%. The aromatic portions of Block A are reduced by a maximum of 25%. The hydrogenated block copolymers styrene-(ethylene-butylene)-two-block and styrene-(ethylene-butylene)-styrene-three-block-co-polymers will contain styre-butadiene-styrene copolymers due to hydrogenation of styrene-butadiene. Block copolymers consist preferably of 20-90% by weight of block A, especially 50-85% by weight of block A. The diene can be integrated into block B in 1,2 or in 1,4 orientations.

The molar mass of block copolymers in component (A2) is preferably 5,000 to 500,000 g/mol, preferably 20,000 to 300,000 g/mol, especially 40,000 to 200,000 g/mol. Suitable hydrogenated block copolymers are commercially available products, such as KRATON®(Kraton Polymers) G1650, G1651, and G1652 as well as TUFTEC® (Asahi Chemical) H1041, H1043, H1052, H1062, H1141 and H1272.

Examples of non-hydrogenated block copolymers are polystyrene-polybutadiene, polystyrene-poly(ethylene-propylene), polystyrene-polyisoprene, poly(α-methyl-styrene)-polybutadiene, polystyrene-polybutadiene-polystyrene (SBS), polystyrene-poly(ethylene-propylene)-polystyrene, polystyrene-polyisoprene-polystyrene and poly(α-methylstyrene-polybutadiene-poly(α-methylstyrene), as well as compounds thereof.

Suitable non-hydrogenated block copolymers that are commercially available are various products with the brand names SOLPRENE® (Phillips), KRATON® (Shell), VECTOR® (Dexco) and SEPTON® (Kuraray). According to another preferred embodiment, the moulding compounds invented here are characterised by the fact that the component (A2) contains a polyolefin homopolymer or an ethylene-α-olefin-copolymer, in particular one that is preferably an EP and/or EPDM elastomer (ethylene-propylene-rubber or rather ethylene-propylene-diene-rubber). For example, this can be an elastomer that is based on an ethylene-C3-12-α-olefin-copolymer with 20-96%, preferably 25-85% by weight, ethyelene, whereby it is particularly preferable that the olefin in the C3-12-α-olefin is selected from the group of propene, 1-butene, 1-pentene, 1-hexene, 1-octene, 1-decene and/or 1-dodecene, and it is particularly preferred that component C be an ethylene-propylene-rubber and/or LLDPE and/or VLDPE.

Alternative or additionally (for example in a compound), (A2) can contain a terpolymer based on ethylene-C3-12-α-olefin with an unconjugated diene, whereby this terpolymer contains 25-85% ethylene by weight and up to a maximum of 10% by weight of the unconjugated diene, whereby it is particularly preferred that the olefin in the C3-12-α-olefin is selected from the group of propene, 1-butene, 1-pentene, 1-hexene, 1-octene, 1-decene and/or 1-dodecene, and/or whereby the unconjugated diene is preferably selected from the group bicyclo (2.2.1.) heptadiene, hexadiene-1.4, dicyclopentadiene, and/or especially 5-ethylidene norbornene.

Ethylene acrylate copolymers may also be considered as elements for component (A2). Further possible moulds as elements for component (A2) are ethylene-butylene-copolymers or compounds (blends) that contain such systems.

Component (A2) preferably has elements with acid anhydride groups that, through a thermal or radical reaction of the main chain polymer with a non-saturated dicarboxylic acid anhydride, a non-saturated dicarboxylic acid, or a non-saturated dicarboxylic acid monoalkyl ester, can be brought to a concentration that suffices for a good bond with the polyamide, whereby reagents are preferably selected from the following group: maleic acid, maleic acid anhydride, maleic acid monobutyl ester, fumaric acid, aconitic acid, and/or itaconic acid anhydride.

Preferably 0.1% to 4.0% by weight of a non-saturated anhydride is grafted to the impact resistance components as an element of (A2) or a non-saturated dicarboxylic acid anhydride or its precursor is grafted together with another non-saturated monomer. In general the grafting degree is preferably in the range of 0.1-1.0%, ideally in the range of 0.3-0.7%.

Component (A2) can also contain a compound of an ethylene-propylene-copolymer and an ethylene-butylene-copolymer, with a maleic acid anhydride grafting degree (MAH grafting degree) in the range of 0.3-0.70. The possible systems listed above for the components can also be used in compounds.

Furthermore, component (A2) can have elements that have functional groups such as carboxylic acid, ester, epoxy, oxazoline, carbodiimide, isocyanate, silanol and carboxylate groups, or contain combinations of two or more of the aforementioned functional groups. Monomers that have these functional groups can be bonded to the elastomer polyolefin through co-polymerisation or grafting. In addition, the IRM can also be modified on the basis of olefin polymers through grafting with a non-saturated silane compound, such as vinyltrimethoxysilane, vinyltriethoxysilane, vinyltriacetosilane, methacryloxypropyltrimethoxysilane, or propenyltrimethoxysilan.

The elastomer polyolefins are static, alternating, or segmented copolymers with linear, branched, or core-shell structure and contain functional groups that can react with the end groups of polyamides so that a sufficient compatibility results between the polyamide and IRM.

The IRMs used as component (A2) therefore include homopolymers or copolymers of olefins such as ethylene, propylene, butene-1, or copolymers of olefins and copolymerisable monomers such as vinyl acetate, (meth-)acrylic acid esters and methyl hexadiene.

Examples of crystalline olefin polymers are low-, medium- and high-density polyethylene, polypropylene, polybutadiene, poly-4-methylpentene, ethylene-propylene-block or static copolymers, ethylene-methyl hexadiene copolymers, propylene-methyl hexadiene copolymers, ethylene-propylene-butene-copolymers, ethylene-propylene-hexene-copolymers, ethylene-propylene-methyl hexadiene copolymers, poly(ethylene vinyl acetate) (EVA), poly(ethylene-ethyl acrylate) (EEA), ethylene-octene-copolymer, ethylene-butene-copolymer, ethylene-hexene-copolymer, ethylene-propylene-diene terpolymers, as well as combinations of the named polymers.

Examples of commercially available impact resistance modifiers that can be used as elements for component (A2) are: TAFMER MC201: g-MAH (−0.6%) blend of 67% EP copolymer (20 mol-% propylene)+33% EB copolymer (15 mol-% butene-1); TAFMER MH5010: g-MAH (−0.6%) ethylene-butylene copolymer; TAFMER MH7010: g-MAH (−0.7%) ethylene-butylene copolymer; Mitsui.

TAFMER MH7020: g-MAH (−0.7%) EP-copolymer from Mitsui Chemicals; EXXELOR VA1801: g-MAH (−0.7%) EP copolymer; EXXELOR VA1803: g-MAH (0.5-0.9%) EP copolymer, amorph; EXXELOR VA1810: g-MAH (−0.5%) EP copolymer; EXXELOR MDEX 94-1 1: g-MAH (0.7%) EPDM, Exxon Mobile Chemical; FUSABOND MN493D: g-MAH (−0.5%) ethylene-octene-copolymer; FUSABOND A EB560D (g-MAH) ethylene-n-butyl-acrylate-copolymer; ELVALOY, DuPont.

An ionomer is preferred in component (A2) in which the polymer-bonded carboxyl groups are completely or partially bonded to one another with metal ions.

Particularly preferred are compound polymersates of butadiene with styrene functionalised by grafting with maleic acid anhydride, nonpolar or polar olefin homo- and copolymers that are created by grafting maleic acid anhydride, and copolymers functionalised with carboxylic acid such as poly(ethene-co-(meth)acrylate acid) in which the acid group is partially neutralised with metal ions.

The preferred proportion of the additional matrix component (A2) should be 0-20% by weight, preferably in a range of 0-10% by weight, and ideally in a range of 0-5% by weight. Preferably there is no other matrix component (A2), meaning that component (A1) is preferred as exclusive in the moulding compound.

In addition to the primarily present high-strength glass fibre (component B1) in the moulding compound, there can also be other glass fibres, different from (B1), in the form of component (B2) and/or in the form of non-glass-based fibres of component (B3) in the moulding compound, whereby the fibre proportion, and therein also the principal glass fibre proportion, meaning preferably more than 50% related to the glass fibre proportion, consists of component (B1). In other words, the ratio of (B1) to the sum of (B2) and (B3) is preferred in all cases to be >1, preferably >2, and ideally >5.

Component (B2) is preferably selected from the group consisting of E-glass fibres (comprised according to ASTM D578-00 of 52-62% silicon dioxide, 12-16% aluminium oxide, 16-25% calcium oxide, 0-10% borax, 0-5% magnesium oxide, 0-2% alkali oxides, 0-1.5% titanium dioxide and 0-0.3% ferric oxide; they preferably have a density of 2.58±0.04 g/cm3; a tensile modulus of 70-75 GPa, a tensile strength of 3000-3500 MPa and an ultimate elongation of 4.5-4.8%), A-glass fibres (63-72% silicon dioxide, 6-10% calcium oxide, 14-16% sodium- and potassium oxide, 0-6% aluminium oxide, 0-6% boric oxide, 0-4% magnesium oxide), C-glass fibres (64-68% silicon dioxide, 11-15% calcium oxide, 7-10% sodium and potassium oxide, 3-5% aluminium oxide, 4-6% boric oxide, 2-4% magnesium oxide), D-glass fibres (72-75% silicon dioxide, 0-1% calcium oxide, 0-4% sodium and potassium oxide, 0-1% aluminium oxide, 21-24% boric oxide), basalt fibres (a mineral fibre with the approximate composition: 52% SiO₂ 17% Al₂O₃, 9% CaO, 5% MgO, 5% Na₂O, 5% ferric oxide as well as other metal oxides), AR glass fibres (55-75% silicon dioxide, 1-1.0% calcium oxide, 11-21% sodium and potassium oxide, 0-5% aluminium oxide, 0-8% boric oxide, 0-12% titanium dioxide, 1-18% zirconium oxide, 0-5% ferric oxide) as well as compounds thereof.

It is particularly preferred that component B2 be a glass fibre that is made of or comprised primarily of silicon dioxide, calcium oxide, and aluminium oxide, with a weight ratio of SiO₂/(CaO+MgO) less than 2.7, preferably less than 2.5, and especially between 2.1 and 2.4.

Component B2 is in particular an E-glass fibre in accordance with ASTM D578-00.

Component (B3) is preferably selected from the group consisting of: carbon fibres, graphite fibres, aramide fibres, nanotubes.

The proportions of components (B2) and of (B3) are preferably zero.

The fibres of component (B1) and/or (B2) and/or (B3) can have a circular or non-circular transverse surface.

Typically, the proportion of component (B2) and/or component (B3) should preferably be 0-10% by weight, preferably in the range of 0-5% by weight. The fibre-shaped aggregates (B) are preferably only component B1, meaning that the proportion of component (B2) and (B3) is zero.

High-strength glass fibre (B1) therefore comprises 10-70% by weight or up to 65% by weight of the moulding compounds; this is used in the form of so-called short fibres (for example, cut glass with a length of 0.2-20 mm) or rovings.

The invented high-strength glass fibre of component (B1) is based preferably on the ternary system silicon dioxide-aluminium oxide-magnesium oxide or on the quaternary system silicon dioxide-aluminium oxide-magnesium oxide-calcium oxide, whereby a composition of 58-70% by weight silicon dioxide (SiO₂), 15-30% by weight aluminium oxide (Al₂O₃), 5-15% by weight magnesium oxide (MgO), 0-10% by weight calcium oxide (CaO) and 0-2% by weight other oxides, such as zirconium dioxide (ZrO₂), boric oxide (B₂O₃), titanium dioxide (TiO₂) or lithium oxide (Li₂O) are preferred.

In another embodiment, the high-strength glass fibre has a composition of 60-67% by weight silicon dioxide (SiO₂), 20-28% by weight aluminium oxide (Al₂O₃), 7-12% by weight magnesium oxide (MgO), 0-9% by weight calcium oxide (CaO) and 1.5% by weight other oxides, such as zirconium dioxide (ZrO₂), boric oxide (B₂O₃), titanium dioxide (TiO₂) or lithium oxide (Li₂O).

Particularly preferred is a high-strength glass fibre with the following composition: 62-66% by weight silicon dioxide (SiO₂), 22-27% by weight aluminium oxide (Al₂O₃), 8-12% by weight magnesium oxide (MgO), 0-9% by weight calcium oxide (CaO) and 0-1% by weight other oxides, such as zirconium dioxide (ZrO₂), boric oxide (B₂O₃), titanium dioxide (TiO₂) or lithium oxide (Li₂O).

The high-strength glass fibre preferably has a tensile strength of greater than or equal to 4000 MPa, and/or an ultimate elongation of at least 5% and a tensile modulus greater than 80 GPa.

The invented high-strength glass fibres of component (B1) preferably have a circular or non-circular transverse surface.

Glass fibres with circular profiles, meaning round glass fibres, typically have a diameter of 5-20 μm, preferably 6-17 μm and ideally 6-13 μm. They are preferably implemented as short glass fibre (cut glass with a length of 0.2 to 20 mm, preferably 2-12 mm).

For flat glass fibres of component (B1) and/or (B2), meaning glass fibres with a non-circular transverse surface, fibres with a proportional dimension from the main transverse axis to the perpendicular minor transverse axis of more than 2, preferably from 2 to 8, and ideally from 2 to 5, are used. So-called flat glass fibres have an oval, elliptical, elliptical with constriction(s) (cocoon fibres), polygonal, rectangular or nearly rectangular transverse surface. Another identifying feature of the flat glass fibres used is that the length of the main transverse axis is preferably 6 to 40 μm, especially 15-30 μm, with a minor transverse axis length of 3-20 μm, preferably 4-10 μm. This imparts the highest possible packing density to the flat glass fibres, meaning that the transverse surface of the glass fibre fills an intended rectangle surrounding the glass fibre cross-section as completely as possible to at least 70%, preferably at least 80%, and ideally to at least 85%.

To strengthen the invented moulding compounds, compounds of glass fibres with circular and non-circular cross sections can also be used, both within component (B1) and within component (B2), whereby the proportion of flat glass fibres preferably predominates, meaning more than 50% by weight of the total mass of fibres.

The invented glass fibres are preferably sealed with a surface suitable for thermoplastics, especially for polyamide, containing a bonding agent based on an amino- or epoxy silane bond, for example. In accordance with another embodiment, the high-strength glass fibres used within component (B1) and within component (B2) as rovings have a diameter of 8-20 μm, preferably 12-18 μm, whereby the cross section of the glass fibres can be round, oval, elliptical, elliptical with constriction(s), polygonal, rectangular or nearly rectangular.

Particularly preferred are so-called flat glass fibres with a transverse axis ratio of 2 to 5. These rovings, especially preferred within component (B1), are integrated into the invented polyamide moulding compounds by means of known methods for manufacturing long fibre-reinforced rod granulate, especially by means of pultrusion processing, in which the endless fibre strand (roving) is completely saturated with polymer melt and then cooled and cut. The long fibre-reinforced rod granulate that is attained in this method, which preferably has a granulate length of 3-25 mm, especially 4-12 mm, can be further processed with conventional processing methods (such as injection moulding or pressing).

Another preferred embodiment is also characterised by the fact that the glass fibres of component (B1) are high-strength glass fibres based on the ternary system silicon dioxide-aluminium oxide-magnesium oxide or on the quaternary system silicon dioxide-aluminium oxide-magnesium oxide-calcium oxide, whereby they preferably have the following composition: 58-70%, preferably 60-67%, by weight silicon dioxide; 15-30%, preferably 20-28%, by weight aluminium oxide; 5-15%, preferably 7-12%, by weight magnesium oxide; 0-10%, preferably 0-9%, by weight calcium oxide; and 0-2%, preferably 0-1.5%, by weight other oxides, especially zirconium dioxide, boric oxide, titanium dioxide, lithium oxide, or a combination of these oxides. The glass fibres of component (B1) are furthermore preferably high-strength glass fibres with the following composition: 62-66% by weight silicon dioxide, 22-27% by weight aluminium oxide, 8-12% by weight magnesium oxide, 0-5% by weight calcium oxide, 0-1% by weight other oxides, especially zirconium dioxide, boric oxide, titanium dioxide, lithium oxide, or a combination of these oxides.

The glass fibres of component (B1) preferably have a tensile strength of at least 3700 MPa, preferably of at least 3800 or 4000 MPa, and/or an ultimate elongation of at least 4.8%, preferably of at least 4.9 or 5.0%, and/or a tensile modulus of more than 75 GPa, preferably of more than 78 or 80 GPa, whereby the glass properties of individual fibres (pristine single filament) must have a diameter of 10 μm and a length of 12.7 mm at a temperature of 23° C. and a relative humidity of 50%.

Specific examples of these high-strength glass fibres for component (B1) are S-glass fibres by Owens Corning with 995-surface, T-glass fibres by Nittobo, HiPertex by 3B, HS4-glass fibres by Sinoma Jinjing Fiberglass, R-glass fibres by Vetrotex as well as S-1- and S-2-glass fibres by AGY.

The glass fibres of component (B1) and/or (B2) are present in the form of short fibres, preferably in the form of cut glass with a length of 0.2-20 mm, or in the form of rovings.

Particulate filler material for component (C) is comprised of filler material familiar to professionals for this function. This includes, in particular, particulate filler material selected from the group consisting of: talc, mica, silicates, quartz, wollastonite, kaolin, silicic acids, magnesium carbonate, magnesium hydroxide, chalk, ground or cut calcium carbonate, lime, feldspar, anorganic pigments, such as barium sulphate, zinc oxide, zinc sulphide, titanium dioxide, ferric oxide, ferric manganese oxide, metal oxides, especially spinels, such as for example copper ferric spinel, copper chromium oxide, zinc ferric oxide, cobalt-chromium oxide, cobalt-aluminium oxide, magnesium aluminium oxide, copper-chromium-manganese-compound oxide, copper-manganese-iron-compound oxide, rutile pigments such as titanium-zinc-rutile, nickel-antimony-titanate, permanent magnetic or magnetisable metals or alloys, concave silicate filler material, aluminium oxide, boron nitride, boron carbide, aluminium nitride, calcium fluoride, and compounds thereof. The filler materials can also have treated surfaces.

Component (C) preferably has an average particle size (D50) of 0.1-40 μm, preferably 0.2-20 μm, and especially 0.3-10 μm. The preferred form of particulate filler material has aspect ratios of L/b1 and L/b2 of no greater than 10, but preferably of no greater than 5, whereby the aspect ratios are described by the quotient of the greatest length L of the particle to its average width b1 or b2. These widths b1 and b2, which are perpendicular to one another, are in a plane perpendicular to the length L.

Furthermore, component (C) preferably has zero different absorption coefficients for electromagnetic, especially UV, VIS or IR radiation, preferably for a wavelength of 1064 nm, preferably with an absorption capacity in visible and/or infrared radiation spectrum with an absorption coefficient of at least 0.05, preferably at least 0.1, and ideally at least 0.2.

Component (A) of the moulding compound contains or is preferably made of polyamide, which can be made of aliphatic, cycloaliphatic, or aromatic monomers.

The invented moulding compounds contain, in particular, partially crystalline, aliphatic polyamides, partially crystalline or amorphous, partially aromatic polyamides, and partially crystalline or amorphous polyamides, for example, based on cycloaliphatic diamine.

The matrix related to the invention of the polyamide moulding compounds, as described above, is based furthermore preferably on at least one partially crystalline, aliphatic (component A1_{—}1) and/or partially aromatic (component A1_{—}2) polyamidde, and/or at least one amorphous polyamide (component A1_{—}3) on the basis of cycloaliphatic diamines or on a compound of the components A1_{—}1 and A1_{—}2, A1_{—}1 and A1_{—}3 or a compound of the types A1_{—}1, A1_{—}2 and A1_{—}3.

The named polyamides can be made of the following dicarboxylic acids: adipic acid, suberic acid, azelaic acid, sebacic acid, undecanedioic acid, dodecane dicarboxylic acid, tridecanoic acid, tetradecanoic acid, pentadecanoic acid, hexadecanoic acid, heptadecanoic acid, octodecanoic acid, C36-dimer fatty acid, isophthalic acid, terephthalic acid, napthalene dicarboxylic acid, cis- and/or ans-cyclohexane-1.4-dicarboxylic acid and/or cis- and/or trans-cyclohexane-1,3-dicarboxylic acid (CHDA) and compounds thereof.

The following monomers are considered as diamines: 1,4-butanediamine, 1,5-pentanediamine, 2-methyl-1,5-pentanediamine, 2-butyl-2-ethyl-1,5-pentanediamine, 1,6-hexanediamine, 2,2,4-trimethyl hexamethylene diamine, 2,4,4-trimethyl hexamethylene diamine, 1,8-octanediamine, 2-methyl-1,8-octanediamine, 1,9.nonanediamine, 1,10-decanediamine, 1,11-undecanediamine, 1,12-dodecanediamine, 1,13-tridecanediamine, 1,14-tetradecanediamine, m-xylylenediamine and p-xylylenediamine.

Furthermore, polyamides can also be built on lactams or amino carboxylic acids α,ωamino acids or lactames with between 6 and 12 carbon atoms, whereby the following selection is named as exemplary: m-aminobenzoic acid, p-aminobenzoic acid caprolactam (CL), ω-aminocaproic acid, ω-aminoheptanoic acid, ω-aminooctanoic acid, ω-aminononanoic acid, ω-aminodecanoic acid, ω-aminoundecanoic acid (AUA), laurolactam (LL) and ω-aminododecanoic acid (ADA). Caprolactam, aminocaproic acid, laurolactam and aminododecanoic acid are particularly preferred.

Suitable cycloaliphatic diamines are those with 6 to 24 carbon atoms, such as bis-(4-amino-3-methyl-cyclohexyl)-methane (MACM), bis-(4-amino-cyclohexyl)-methane (PACM), bis-(4-Amino-3-ethyl-cyclohexyl)-methane (EACM), bis-(4-Amino-3,5-dimethyl-cyclohexyl)-methane (TMACM), 2,6-norbornandiamine or 2,6-bis-(aminomethyl)-norbornane or 1,3-cyclohexyldiamine, 1,4-cyclohexyldiamine, bis-(1,3-aminomethyl)cyclohexane, isophorondiamine, cyclohexandiamine, 1,3-bis-(aminomethyl)cyclohexane, 1,4-bis-(aminomethyl)cyclohexane, isophorondiamine, norbornandimethylamine, 2,2-(4,4′-diaminodicyclohexyl)propane (PACP) or compounds thereof. Alkyl-substituted bis-(aminocyclohexyl)methane or bis-(aminocyclohexyl)propane are particularly preferred. Alkyl substitutes are linear and/or branched C1-C6, preferably C1-C4 alkyl groups, especially, methyl-, ethyl-, propyl-, isopropyl- or butyl-groups, with methyl groups particularly preferred. In a particularly preferred embodiment, bis-(4-amino-3-methyl-cyclohexl)-methane (MACM) is used as an alkyl-substituted bis-(aminocyclohexyl)methane. Polyamides A1_{—}1, A1_{—}2 or A1_{—}3 preferably have a solution viscosity of ηᵣₑₗ, measured in m-cresol (0.5% by weight, 20° C.) in a range of 1.4 to 3.0, preferably in the range from 1.5 to 2.7, especially in the range of 1.5 to 2.4.

The following aliphatic polyamides are preferred: polyamide 46, polyamide 6, polyamide 66, polyamide 11, polyamide 12, polyamide 1212, polyamide 1010, polyamide 1012, polyamide 1112, polyamide 610, polyamide 612, polyamide 69, polyamide 810, or their mixtures, compounds or alloys.

Preferred amorphous or partially crystalline polyamides based on cycloaliphatic diamines are in particular MACM9, MACM10, MACM11, MACM12, MACM13, MACM14, MACM16, MACM18, PACM9, PACM10, PACM11, PACM12, PACM13, PACM14, PACM16, PACM18 or co-polyamides, such as MACMI/12, MACMT/12, 6I/6T/MACMI/MACMT/12, 3-6T, 6I/MACMI/MACMT, 6I/PACMI/PACMT, 6I/6T/MACMI, MACMI/MACM36, 12/PACMI or 12/MACMT, 6/PACMT, 6/IPDT or mixtures thereof, MACM10/PACM10 and MACM12/PACM12, and mixtures thereof.

Partially aromatic polyamides are based preferably either on aromatic dicarboxylic acids with 8 to 18, preferably 8 to 14, carbon atoms or on diamines with aromatic structural units, such as PXDA and/or MXDA. Preferred aromatic dicarboxylic acids are TPS, napthalene dicarboxylic acid, and IPS. Preferred partial aromatic polyamides are based on the following polyamide systems: 4T, 5T, DT, 6T, 9T, MT, 10T, 12T, 4I, 5I, DI, 6I, 9I, MI, 10I, 12I. As long as the processing temperature allows it, these can be combined with one another as homopolyamides as well as binary, ternary and quaternary co-polyamides. Furthermore, aliphatic polyamide systems such as PA46, PA6, PA66, PA111, PA12, PA1212, PA1010, PA1012, PA610, PA612, PA69, PA810 can be combined as well.

Preferred partial aromatic polyamides are: MXD6, MXD10, MXDI/MXD6, 6T/6I, 6T/66, 6T/10T, 6T/12, 11/10T, 12/10T, 10T/1010, 10I/10T, 10T/1012, 9MT (M stands for 2-methyl octane diamine), 12T.

For A1_{—}2 polyamides, the co-polyamides 6T/6I, 10I/10T, MXD6/MXDI and the homo-polyamides MACM12 and MXD6 are preferred. Two different composition ranges are particularly preferred for the 6T/6I co-polyamides. First, there are the amorphous co-polyamides with a share of less than 50% by mole 6T units, whereby a composition range for 6T:6I of 20:80 to 45:55 is preferred; second, there are the high melting point co-polyamides with a 6T proportion greater than 50% by mole, whereby a composition range for 6T:6I of 55:45 to 80:20, especially of 65:35 to 75:25, is preferred. With regard to the co-polyamide MXD6/MXDI, MXD6-rich compositions are preferred, especially with an MXD6 content of greater than 80% by mole, ideally between 82% to 95% by mole.

In terms of a polymer blend containing the polyamide components A1_{—}1 and A1_{—}2, A1_{—}1 and A1_{—}3, A1_{—}2 and A1_{—}3 as well as A1_{—}1, A1_{—}2 and A1_{—}3, the following compositions are preferred:
(A1_{—}1): PA 66
(A1_{—}2): PA 6I/6T, whereby the mole ratio is in a range from 65:35 to 75:25 or particularly 67:33.
(A1_{—}1): PA 610 and/or PA1010, whereby in a mixture the components are used in a ratio from 1:1 to 4:1.
(A1_{—}2): PA 6I/6T, whereby the mole ratio is in a range from 65:35 to 75:25 or particularly 67:33.
(A1_{—}1): Compound of PA 6 and PA66, in a ratio from 1:2 to 1:4, particularly 1:4.
(A1_{—}2): PA 6I/6T, whereby the mole ratio is in a range from 65:35 to 75:25 or particularly 67:33.
(A1_{—}1): PA 66
(A1_{—}2): PA 6T/6I, whereby the mole ratio is in a range from 60:40 to 75:25 or particularly 70:30.
(A1_{—}1): PA 66
(A1_{—}2): PA 6T/66, whereby the mole ratio is in a range from 50:50 to 70:30 or particularly 55:45.
(A1_{—}1): PA 66
(A1_{—}2): MXD6, MXD10 or PA MXD6/MXDI, whereby the mole ratio in the co-polyamide is in a range from 70:30 to 90:10 or particularly 88:12.
(A1_{—}1): PA 12
(A1_{—}3): PA MACM12.
(A1_{—}1): PA 12
(A1_{—}3): PA MACMI/12, where the content of laurolactam is in a range of 15-45% by mole, preferably less than 40% by mole, especially in a range of 20-35% by mole.

The preferred proportion of component (A1_{—}1) is in a range of 50-90% by weight, especially 60-85% by weight, and component (A1_{—}2) and/or (A1_{—}3) is preferably in a range from 10-50% by weight, especially in a range of 15-40% by weight.

In a special embodiment, the following compositions are preferred for polymer blends (polyamide matrix):
(A1_{—}1): 50-100% by weight PA 1010 or PA 1012 or PA 11 or PA 12
(A1_{—}3): 0-50% by weight PA MACM12 or PA MACMI/12 or PA PACM12/MACM12,
(A1_{—}1): 55-85% by weight PA 610 or PA 612 or PA 1010 or PA 1012 or PA 1210 or PA1212
(A1_{—}2): 15-45% by weight PA 6T/6I or PA 10T/10I, whereby the 61 or 10I proportion is 55-80% by mole, preferably 60-75% by mole.
(A1_{—}1): 70-100% by weight compound of PA 6 and PA66, in a ratio from 1:2 to 1:4, particularly 1:4
(A1_{—}2): 0-30% by weight PA 6I/6T, whereby the mole ratio is in a range from 65:35 to 75:25 or particularly 67:33.

In another embodiment, component A1_{—}2 had a glass transition temperature of 90° C., preferably greater than 110° C. and ideally greater than 140° C.

The following embodiment is particularly preferred:
(A1_{—}1): 55-85% by weight PA 610 or PA 612 or PA 1010 or PA 1012 or PA 1210 or PA1212
(A1_{—}2): 15-45% by weight PA 6T/6I or PA 10T/10I, whereby the proportion of 61 or 10I is 55-80% by mole, preferably 60-75% by mole.

Partially aromatic, partially crystalline systems can be used as component (A1).

Also preferred are moulding compounds that are suitable for reflow soldering, meaning that they can withstand short-term temperatures of 260-270° C. without warping and blistering.

According to a preferred embodiment, component (A1), which then preferably makes up the totality of (A), is made of PA 10T/6T co-polyamide, which is built of:

(AA) 40-95% by mole, preferably 60-95% by mole 10T units formed of the monomers 1,10-decanediamine and terephthalic acid;

(BB) 5-60% by mole, preferably 5-40% by mole 6T units formed of the monomers 1,6-hexanediamine and terephthalic acid.

Up to 30% of the monomers within component (A1) in this configuration can be replaced, meaning that the above applies on the one hand with the stipulation that in component (A1), independently of one another in (AA) and/or (BB), up to 30% by mole terephthalic acid, as related to the total amount of dicarboxylic acids, can be replaced by other aromatic, aliphatic or cycloaliphatic dicarboxylic acids with 6 to 36 carbon atoms. Furthermore, the above applies on the other hand with the stipulation that in component (A1), independently of one another in (AA) and/or (BB), up to 30% by mole of 1,10-decanediamine and 1,6-hexanediamine respectively, related to the total amount of diamines, can be replaced by other diamines with 4 to 36 carbon atoms. Finally, the above applies further with the stipulation that no more than 30% by mole of component (A1), as related to the total volume of monomers, can be formed by lactams or amino acids. It is preferred, however, that this substitution of monomers within component (A1) is less than 20% in accordance with the above stipulations, preferably less than 10%, and ideally there is absolutely no substitution. Overall, an additional stipulation applies that the sum of monomers that replace the terephthalic acid, 1,6-hexanediamine and 1,10-decanediamine (meaning the total proportion of other aromatic, aliphatic or cycloaliphatic dicarboxylic acids with 6 to 36 carbon atoms, of other diamines with 4 to 36 carbon atoms, and of lactams or amino acids) does not exceed a concentration of 30% by mole, preferably 20% by mole, especially 10% by mole in relation to the total amount of monomers used in component A.

According to a preferred embodiment, component (A1), which then preferably makes up the totality of (A), is made of polyamide 10T/10I/6T/6I, namely a partially aromatic, partially crystalline co-polyamide made of 100% by weight diacids comprised of:

72.0-98.3% by weight terephthalic acid (TPS);

28.0-1.7% by weight isophthalic acid (IPS)

and 100% by weight diamine proportion comprised of:

51.0-80.0% by weight 1,6-hexanediamine (HMDA);

20.0-49.0% by weight C9-C12 diamine;

whereby for C9-C12 diamine is a diamine from the group: 1,9-nonanediamine, methyl-1,8-octanediamine, 1,10-decanediamine, 1,11-undecanediamine, 1,12-dodecanediamine, or a mixture of such diamines, whereby 1,10-decanediamine and 1,12-dodecanediamine are preferred, and 1,10-decanediamine alone is particularly preferred. A polyamide system of PA 10T/10I/6T/6I is therefore preferred, whereby the above concentrations apply.

According to a preferred embodiment, component (A1), which then preferably makes up the totality of (A), is made of polyamide 6T/6I/6, namely a partially aromatic, partially crystalline co-polyamide made of terephthalic acid (TPS), isophthalic acid (IPS), 1,6-hexanediamine (HMDA), and caprolactam (CLM) or aminocaproic acid, whereby the co-polyamide 6T/6I/6 has the composition 60-80/15-25/5-15% by weight, with 65-75/17.5-22.5/7.5-12.5% by weight particularly preferred.

In summary, component (A1) is a homo-polyamide and/or co-polyamide made of aliphatic, cycloaliphatic and/or aromatic monomers, preferably of a compound made of a partially crystalline, aliphatic polyamide (A1_{—}1) and/or a partial aromatic polyamide (A1_{—}2), and/or an amorphous polyamide (A1_{—}3), whereby the polyamides in component (A1) are preferably selected from the following group: polyamide 46, polyamide 6, polyamide 66, polyamide 11, polyamide 12, polyamide 1212, polyamide 1010, polyamide 1012, polyamide 1112, polyamide 610, polyamide 612, polyamide 69, polyamide 810, MACM9, MACM10, MACM11, MACM12, MACM13, MACM14, MACM16, MACM18, PACM9, PACM10, PACM11, PACM12, PACM13, PACM14, PACM16, PACM18 or co-polyamides such as MACMI/12, MACMT/12, 6I/6T/MACMI/MACMT/12, 3-6T, 6I/MACMI/MACMT, 6I/PACMI/PACMT, 6I/6T/MACMI, MACMI/MACM36, 12/PACMI, 12/MACMT, 6/PACMT, 6/IPDT, MACM10/PACM10, MACM12/PACM12, MXD6, MXD10, MXDI/MXD6, 6T/6I, 6T/66, 6T/10T, 6T/12, 11/10T, 12/10T, 10T/1010, 10I/10T, 10T/1012, 9MT, 12T, as well as compounds of the respective blends thereof.

Of course, the invented thermoplastic polyamide moulding compounds can also contain conventional and generally known additives in the form of component (D), which consists of a group comprised of bonding agents, halogen-containing flame retardants, halogen-free flame retardants, stabilisers, antioxidant agents, antioxidants, antiozonants, light stabilisers, UV stabilisers, UV absorbers, UV blockers, inorganic heat stabilisers, especially based on copper halides and alkali halides, organic heat stabilisers, conductivity additives, carbon black, optical brighteners, processing aids, nucleation aids, crystallisation catalysts, crystallisation inhibitors, flow-inducing agents, lubricants, mould release agents, softening agents, pigments, colours, tracers and compounds thereof. Specifically, component (D) is preferably selected from a group consisting of: bonding agents, flame retardants, especially flame retardants containing or free of halogen, stabilisers, antioxidant agents, antioxidants, antiozonants, light stabilisers, UV stabilisers, UV absorbers, UV blockers, inorganic heat stabilisers, especially based on copper halide and/or alkali halides, organic heat stabilisers, conductivity additives, carbon black, optical lighteners, processing aids, nucleation agents, crystallisation catalysts, crystallisation inhibitors, flow-inducing agents, lubricants, mould release agents, softening agents, organic pigments and colours, tracers and compounds thereof.

Furthermore, the invention here is related to a device, especially a device with electric conducive paths on the basis of a moulding compound under one of the any of the preceding claims.

Additional designs are listed in the dependent claims.

### DESCRIPTION OF PREFERRED EMBODIMENTS

The invention shall be described in the following by means of specific embodiment examples (B) and be compared with less powerful state-of-the-art systems (VB). The embodiment examples provided in the following serve to support the invention and provide evidence of its divergence from the state of the art; they should not, however, be consulted to restrict the general object of invention as defined in the patent claims enumerated here.

### Examples B1 to B6 and Comparative Examples VB1 to VB6

The components displayed in Tables 1 to 4 were compounded in a double-wall extruder made by the company Werner and Pfleiderer, with a screw diameter of 25 mm under the given process parameters (see Table 1), whereby the polyamide granulate as well as the filler materials were measured out in the feed section while the glass fibres were measured out via a sidefeeder through 3 housing units in front of the nozzle leading to the polymer melt. The compounds summarised in Tables 2, 3 and 4 were removed as a strand from a nozzle with a 3 mm diameter and granulated after water cooling. The granulate is dried for 24 hours at 110° C. in a vacuum of 30 mbar. For the moulding compounds in Table 5, granulation was done by means of underwater pellitising and hot-cuts under water, during which the polymer melt was pushed through a hole-type nozzle and pelletised directly after exiting the nozzle by a rotating blade in a stream of water. After granulation and drying at 120° C. for 24 hours, the granulate properties were measured and the specimens manufactured.

TABLE 1
Compounding and injection moulding conditions for the
examples and comparative examples

| | | Conditions for examples | | | |
|---|---|---|---|---|---|
| | | in Table no. | | | |
| Compounding/processing parameters | | 2 | 3 | 4 | 5 |
| Compounding | Cylinder temperatures | 260 | 270 | 250 | 340 |
| | Screw speed | 200 | 200 | 150 | 150 |
| | Throughput | 10 | 10 | 8 | 8 |
| Injection | Cylinder temperatures | 260 | 260 | 240 | 340 |
| moulding | Tool temperature | 40 | 40 | 80 | 140 |
| | Circumferential screw | 15 | 15 | 15 | 15 |
| | speed | | | | |

Processing:

The compounds are sprayed with an Arburg Allrounder 320-210-750 injection moulding machine on specimens at the defined cylinder temperatures of zones 1 to 4 and a defined tool temperature (see Table 1).

TABLE 2
Composition and mechanical characteristics of example B1
and comparative examples VB1-1 to VB1-5

| | | | | | | |
|---|---|---|---|---|---|---|
| Unit | B1 | VB1-1 | VB1-2 | VB1-3 | VB1-4 | VB1-5 |

Composition

| | | | | | | | |
|---|---|---|---|---|---|---|---|
| PA1010 | % by | 36.6 | 36.6 | 36.6 | 36.6 | 36.6 | 36.6 |
| | weight | | | | | | |
| PA 6I/6T | % by | 9.1 | 9.1 | 9.1 | 9.1 | 9.1 | 9.1 |
| (70:30) | weight | | | | | | |
| E10 glass | % by | | | 50.0 | | | 54.0 |
| fibre | weight | | | | | | |
| S10 glass | % by | 50.0 | | | 54.0 | | |
| fibre | weight | | | | | | |
| E7x28 glass | % by | | 50 | | | 54 | |
| fibre | weight | | | | | | |
| Copper | % by | 4.0 | 4.0 | 4.0 | 0 | 0 | 0 |
| chromite | weight | | | | | | |
| Irganox 1098 | % by | 0.3 | 0.3 | 0.3 | 0.3 | 0.3 | 0.3 |
| | weight | | | | | | |

Characteristics

| | | | | | | | |
|---|---|---|---|---|---|---|---|
| Tensile | MPa | 15300 | 12900 | 11500 | 17300 | 15500 | 14300 |
| modulus | | | | | | | |
| Tensile | MPa | 167 | 139 | 135 | 205 | 207 | 203 |
| strength | | | | | | | |
| Ultimate | % | 2.5 | 2.0 | 2.1 | 3.4 | 2.9 | 3.5 |
| elongation | | | | | | | |
| Impact | kJ/m² | 59 | 50 | 44 | 74 | 93 | 78 |
| resistance | | | | | | | |
| 23° C. | | | | | | | |
| Notch impact | kJ/m² | 11 | 9 | 8 | 14 | 20 | 14 |
| resistance | | | | | | | |
| 23° | | | | | | | |

TABLE 3
Composition and mechanical characteristics of example B2
and comparative examples VB2-1 to VB2-5.

| | | | | | | |
|---|---|---|---|---|---|---|
| Unit | B2 | VB2-1 | VB2-2 | VB2-3 | VB2-4 | VB2-5 |

Composition

| | | | | | | | |
|---|---|---|---|---|---|---|---|
| PA 12 | % by | 45.7 | 45.7 | 45.7 | 49.7 | 49.7 | 49.7 |
| | weight | | | | | | |
| E10 glass | % by | | | 50.0 | | | 50.0 |
| fibre | weight | | | | | | |
| S10 glass | % by | 50.0 | | | 50.0 | | |
| fibre | weight | | | | | | |
| E7x28 glass | % by | | 50 | | | 50 | |
| fibre | weight | | | | | | |
| Copper | % by | 4.0 | 4.0 | 4.0 | 0 | 0 | 0 |
| chromite | weight | | | | | | |
| Irganox 1098 | % by | 0.3 | 0.3 | 0.3 | 0.3 | 0.3 | 0.3 |
| | weight | | | | | | |

Characteristics

| | | | | | | | |
|---|---|---|---|---|---|---|---|
| Tensile | MPa | 12900 | 12400 | 11100 | 13500 | 13200 | 12000 |
| modulus | | | | | | | |
| Tensile | MPa | 152 | 119 | 115 | 165 | 180 | 160 |
| strength | | | | | | | |
| Ultimate | % | 3.3 | 2.6 | 2.8 | 5.5 | 3.3 | 5.3 |
| elongation | | | | | | | |
| Impact | kJ/m² | 65 | 55 | 48 | 78 | 98 | 73 |
| resistance | | | | | | | |
| 23° C. | | | | | | | |
| Notch impact | kJ/m² | 18 | 16 | 12 | 24 | 29 | 23 |
| resistance | | | | | | | |
| 23° C. | | | | | | | |

TABLE 4
Composition and mechanical characteristics of examples B3
and B4 as well as comparative examples VB3-1 to VB3-3 and VB4.

| | | | | | | |
|---|---|---|---|---|---|---|
| Unit | B3 | B4 | VB3-1 | VB4 | VB3-2 | VB3-3 |

Composition

| | | | | | | | |
|---|---|---|---|---|---|---|---|
| PA MACM12 | % by | 31.3 | 32.6 | 31.3 | 32.6 | 34.7 | 34.7 |
| | weight | | | | | | |
| PA12 | % by | 13.5 | 14 | 13.5 | 14 | 15 | 15 |
| | weight | | | | | | |
| E10 glass | % by | | | 45 | 47 | | 50 |
| fibre | weight | | | | | | |
| S10 glass | % by | 45 | 47 | | | 50 | |
| fibre | weight | | | | | | |
| Zinc sulphide | % by | 9.9 | 6.1 | 9.9 | 6.1 | 0 | 0 |
| | weight | | | | | | |
| Irganox 1098 | % by | 0.3 | 0.3 | 0.3 | 0.3 | 0.3 | 0.3 |
| | weight | | | | | | |

Characteristics

| | | | | | | | |
|---|---|---|---|---|---|---|---|
| Tensile | MPa | 15600 | 14800 | 13400 | 12900 | 13800 | 12000 |
| modulus | | | | | | | |
| Tensile | MPa | 177 | 174 | 159 | 158 | 176 | 167 |
| strength | | | | | | | |
| Ultimate | % | 2.3 | 2.5 | 2.4 | 2.5 | 2.7 | 3.1 |
| elongation | | | | | | | |
| Impact | kJ/m² | 52 | 55 | 48 | 52 | 68 | 74 |
| resistance | | | | | | | |
| 23° C. | | | | | | | |
| Notch impact | kJ/m² | 15 | 16 | 14 | 15 | 18 | 20 |
| resistance | | | | | | | |
| 23° C. | | | | | | | |

TABLE 5
Composition and mechanical characteristics of examples B5
and B6 as well as comparative examples VB5 and VB6.

| | | | | |
|---|---|---|---|---|
| Unit | B5 | VB5 | B6 | VB6 |

Composition

| | | | | | |
|---|---|---|---|---|---|
| PA 6T/6I (70:30) | % by | 59.2 | 59.2 | 49.2 | 49.2 |
| | weight | | | | |
| E10 glass fibre | % by | 0 | 20.0 | | 12.5 |
| | weight | | | | |
| S10 glass fibre | % by | 20.0 | 0 | 12.5 | 0 |
| | weight | | | | |
| Titanium dioxide | % by | 20.0 | 20.0 | 20.0 | 20.0 |
| | weight | | | | |
| Calcium carbonate | % by | 0 | 0 | 17.5 | 17.5 |
| | weight | | | | |
| Irganox 1098 | % by | 0.3 | 0.3 | 0.3 | 0.3 |
| | weight | | | | |
| Licowax S | % by | 0.5 | 0.5 | 0.5 | 0.5 |
| | weight | | | | |

Characteristics

| | | | | | |
|---|---|---|---|---|---|
| Tensile modulus | MPa | 11200 | 10300 | 10800 | 9300 |
| Tensile strength | MPa | 148 | 124 | 97 | 82 |
| Ultimate | % | 1.7 | 1.4 | 1.3 | 1.0 |
| elongation | | | | | |
| Impact resistance | kJ/m² | 36 | 25 | 25 | 20 |
| 23° C. | | | | | |
| Notch impact | kJ/m² | 4.8 | 4.0 | 4.1 | 3.2 |
| resistance 23° C. | | | | | |

| | |
|---|---|
| Legend: | |
| PA 6T/6I (70:30) | Partially crystalline, partially aromatic polyamide |
| | based on terephthalic acid, isophthalic acid and |
| | 1,6-hexanediamine, with a melting point of 325° C. |
| | and a solution viscosity of 1.58. |
| PA 6T/6I (30:70) | Amorphous, partially aromatic polyamide based on |
| | terephthalic acid, isophthalic acid and 1,6- |
| | hexanediamine, with a glass transition temperature |
| | of 125° C. and a solution viscosity of 1.54. |
| PA 1010 | Partially crystalline, aliphatic polyamide based on |
| | 1,10-decanediamine and sebacic acid, with a melting |
| | point of 200° C. and a solution viscosity of 1.78. |
| PA 12 | Partially crystalline, aliphatic polyamide based on |
| | laurolactam, with a melting point of 178° C. and a |
| | solution viscosity of 1.96. |
| PA MACM12 | Amorphous polyamide based on bis- |
| | (4•amino-3-methyl-cyclohexyl)-methane and |
| | dodecane dicarboxylic acid, with a glass |
| | transition temperature of 156° C. and a |
| | solution viscosity of 1.82. |
| Glass fibre E10 | Cut glass fibres Vetrotex 995 of E-glass, with a |
| | length of 4.5 mm and a diameter of 10 μm (circular |
| | cross section) by Owens Corning Fiberglass. |
| F7×28 glass fibre | Cut glass fibre CSG3PA-820 made |
| | of E-glass, with a length of 3 mm, a main transverse |
| | axis of 28 μm, a minor transverse axis of 7 μm |
| | and an axial ratio of 4 (non-circular cross section) |
| | by NITTO BOSEKI, Japan. |
| Glass fibre S10 | Cut glass fibres Vetrotex 995 of S-glass, with a |
| | length of 4.5 mm and a diameter of 10 μm (circular |
| | cross-section) by Owens Corning Fiberglass. |
| Copper chromite | Shepherd Schwarz 30C965 (The Shepherd Color |
| | Company), copper chromium oxide (CuCr₂O₄), |
| | average particle size (d50) in a range from 0.6 μm. |
| Zinc sulphide | Sachtolith HD-S (Sachtleben), average particle size |
| | in range of 0.30 to 0.35 μm. |
| Titanium dioxide | Ti-Pure R-104 (DuPont), average particle size |
| | in range of 0.22 μm. |
| Calcium carbonate | Socal P3 (Solvay), average particle size in |
| | range of 0.18-0.50 μm. |

Contrary to expectations, comparative testing in VB1-3 to VB1-5 of S-glass fibres resulted in no advantages in comparison to round or flat E-glass fibre. The values for tensile strength, ultimate elongation and impact resistance selected for the moulding compounds mitigate against choosing S-glass fibre. The round E-glass fibre is nearly identical up to the tensile modulus; flat E-glass fibre is clearly superior in tensile strength and impact resistance.

If we now add to these moulding compounds a particulate filler material, such as copper chromite (CuCr₂O₄), in a concentration of 4%, for example, then the mechanical characteristics of all observed moulding compounds deteriorate, in some cases dramatically.

However, the mechanical characteristics of the moulding compound (B1) reinforced with S-glass fibre do not deteriorate as quickly as moulding compounds based on E-glass (VB1-1 and VB1-2).

The moulding compounds that are based on polyamide 12 behave in a similar way and are summarised in Table 2. A filler-free, S-glass-reinforced moulding compound (VB2-3) had scarcely any advantages in terms of mechanical characteristics in comparison to the inexpensive E-glass fibre (VB2-5) and even had disadvantages in comparison to flat E-glass fibre (VB2-4). Only when copper chromite (CuCr₂O₄) is added do the advantages of S-glass fibre become apparent, namely through significantly improved tensile strength, higher ultimate elongation, and impact resistance.

Even in an overwhelmingly amorphous matrix, as in the examples B3, B4, VB3-1 to VB3-3, and VB4, roughly the same relations as described above resulted. The invented moulding compound resulted in a significantly higher tensile strength and improved impact resistance with significantly higher stiffness. The unpigmented moulding compounds based on PA MACM12 or a mixture of PA MACM12 with PA12 had surprisingly good transparency with high S-glass fibre content. A 50% by weight, S-glass reinforced PA MACM12 had a light transmission of 80% under the ASTM D1003 method (light type CIE-C). The measurement of light transmission was conducted in the following experiments on a device called a Haze Guard Plus from the company BYK Gardner (Germany) on round plates 70×2 mm.

The measurements were done in accordance with the following norms and the following specimens:

Tensile modulus:

ISO 527 with a tensile speed of 1 mm/min

ISO.tension bar, norm: ISO/CD 3167, Type A1, 170×20/10×4 mm,

Temperature 23° C.

Tensile strength, ultimate elongation:

ISO 527 with a tensile speed of 5 mm/min

ISO.tension bar, norm: ISO/CD 3167, Type A1, 170×20/10×4 mm,

Temperature 23° C.

impact resistance, notch impact resistance according to Charpy:

ISO 179

ISO.test rod, norm: ISO/CD 3167, Type B1, 80×10×4 mm at a temperature of 23° C.

melting point (Tm), enthalpy of fusion (ΔHm), and glass transition temperature (Tg):

ISO Norm 11357-11-2

Granulate

Differential Scanning calorimetry (DSC) was performed with a heating rate of 20° C./min. The temperature of onset is given for the glass transition temperature (Tg).

Relative viscosity:

DIN EN ISO 307, in 0.5% by weight m-cresol solution, temperature 20° C.

Granulate

1. A thermoplastic moulding compound consisting of:
(A) 20-88% by weight thermoplastic synthetic;
(B) 10-70% by weight fibre-shaped aggregates;
(B1) 10-70% by weight glass fibres that consist primarily of silicon dioxide, aluminium oxide, and magnesium oxide;
(B2) 0-20% by weight of glass fibres that differ from the fibres in components (B1);
(B3) 0-20% by weight of additional fibre-shaped aggregates that differ from the fibres in components (B1) and (B2), are not based on glass, and are selected from the following group: carbon fibres, graphite fibres, aramide fibres, nanotubes;
(C) 2-40% by weight particulate filler material;
(D) 0-2% by weight additives;
wherein the sum of (A) through (D) equals 100% weight.

2. The thermoplastic moulding compound according to claim 1, wherein the glass fibres of component (B1) have a magnesium oxide content of at least 5% by weight.

3. The thermoplastic moulding compound according to claim 1, wherein the glass fibres of component (B1) have a calcium oxide content of at most 10% by weight.

4. The thermoplastic moulding compound according to claim 1, wherein the thermoplastic component (A) consists of polyamide (A1) or a mixture of polyamides, with the proviso that up to 40% can be replaced by a thermoplastic synthetic (A2) that is not polyamide-based.

5. The thermoplastic moulding compound according to claim 4, wherein the proportion of component (A) is 25-82% by weight.

6. The thermoplastic moulding compound according to claim 4, wherein the proportion of component (B1) is 15-60% by weight.

7. The thermoplastic moulding compound according to claim 4, wherein the proportion of component (C) is 3-25% by weight.

8. The thermoplastic moulding compound according to claim 1, wherein component (A) is selected from the group consisting of: polyamide, polycarbonate, polystyrene, polymethyl methacrylate, acrylonitrile-butadiene-styrene copolymer, acrylonitrile-styrene copolymer, polyolefin, polyoxymethylene, polyester, polysulphone, polyphenylene ether, polyphenylsulphone, polyphenylene oxide, liquid crystalline polymers, polyether ketone, polyether ether ketone, polyimide, polyamide-imide, polyester imide, polyetheramide, polyesteramide, polyether ester amide, polyurethane, polysiloxane, polyacrylate, polymethyl acrylate and compounds or copolymers based on such systems.

9. The thermoplastic moulding compound according to claim 1, wherein the glass fibres of component (B1) are high-strength glass fibres based on the ternary system silicon dioxide-aluminium oxide-magnesium oxide or on the quaternary system silicon dioxide-aluminium oxide-magnesium oxide-calcium oxide.

10. The thermoplastic moulding compound according to claim 9, wherein the glass fibres of component (B1) are high-strength glass fibres with the following composition: 62-66% by weight silicon dioxide (SiO₂), 22-27% by weight aluminium oxide (Al₂O₃), 8-12% by weight magnesium oxide (MgO), 0-5% by weight calcium oxide (CaO) and 0-1% by weight other oxides.

11. The thermoplastic moulding compound according to claim 1, wherein the glass fibres of component (B1) have a tensile strength of at least 3700 MPa, as well as an ultimate elongation of at least 4.8%, and a tensile modulus of 75-90 GPa.

12. The thermoplastic moulding compound according to claim 1, wherein the glass fibres of component (B1) and/or (B2) are present in the form of short fibres, or in the form of rovings.

13. The thermoplastic moulding compound according to claim 1, wherein component (C) is a particulate filler material selected from the group consisting of: talc, mica, silicates, quartz, wollastonite, kaolin, silicic acids, magnesium carbonate, magnesium hydroxide, chalk, ground or cut calcium carbonate, lime, feldspar, anorganic pigments, ferric oxide, ferric manganese oxide, metal oxides, magnesium aluminium oxide, copper-chromium-manganese-compound oxides, copper-manganese-iron-compound oxides, copper chromium oxide, zinc-ferric oxide, cobalt chromium oxide, cobalt-aluminium oxide, magnesium aluminium oxide, rutile pigments nickel-antimony-titanate, chromium-antimony-titanate, permanent magnetic or magnetisable metals or alloys, concave silicate filler material, aluminium oxide, boron nitride, boron carbide, aluminium nitride, calcium fluoride, and compounds and/or surface-treated forms thereof.

14. The thermoplastic moulding compound according to claim 11, wherein the particles of component (C) have an average particle size (D₅₀) of 0.1-40 μm, and/or an aspect ratio of at most 10, or is mainly formed by such particles.

15. The thermoplastic moulding compound according to claim 1, wherein component (A1) is a homo-polyamide and/or co-polyamide made of aliphatic, cycloaliphatic and/or aromatic monomers and/or an amorphous polyamide (A1_{—}3), as well as mixtures and blends thereof.

16. The thermoplastic moulding compound according to claim 1, wherein component (A) or component (A2) is selected according to claim 4 from the group consisting of: impact resistance modifiers, and/or wherein the component (D) is selected from a group consisting of: bonding agents, flame retardants, stabilisers, antioxidant agents, antioxidants, antiozonants, light stabilisers, UV stabilisers, UV absorbers, UV blockers, inorganic heat stabilisers, conductivity additives, carbon black, optical lighteners, processing aids, nucleation agents, crystallisation catalysts, crystallisation inhibitor, flow-inducing agents, lubricants, mould release agents, softening agent, pigments, colours, tracers and compounds thereof.

17. Device on the basis of a moulding compound according to claim 1.

18. The thermoplastic moulding compound according to claim 1, wherein the glass fibres of component (B1) have a calcium oxide content of 5% by weight.

19. The thermoplastic moulding compound according to claim 1, wherein the thermoplastic component (A) consists of polyamide (A1) or a mixture of polyamides, with the proviso that up to 20% can be replaced by a thermoplastic synthetic (A2) that is not polyamide-based.

20. The thermoplastic moulding compound according to claim 1, wherein the thermoplastic component (A) consists of polyamide (A1) or a mixture of polyamides.

21. The thermoplastic moulding compound according to claim 4, wherein the proportion of component (A) is in a range of 30-77% by weight.

22. The thermoplastic moulding compound according to claim 4, wherein the proportion of component (B1) is in a range of 20-55% by weight.

23. The thermoplastic moulding compound according to claim 4, wherein the proportion of component (C) is in a range of 3-15% by weight.

24. The thermoplastic moulding compound according to claim 1, wherein component (A) is selected from the group consisting of: polyamide, polycarbonate, polystyrene, polymethyl methacrylate, acrylonitrile-butadiene-styrene copolymer, acrylonitrile-styrene copolymer, polyolefin, polyoxymethylene, polyethylene terephthalate, polybutylene terephthalate, PSU, PESU, PPSU, polyphenylene ether, polyphenylsulphone, polyphenylene oxide, liquid crystalline polymers, polyether ketone, polyether ether ketone, polyimide, polyamide-imide, polyester imide, polyetheramide, polyesteramide, polyether ester amide, TPU, PUR, polysiloxane, polyacrylate, polymethyl acrylate and compounds or copolymers based on such systems, optionally with one or several impact resistance modifiers.

25. The thermoplastic moulding compound according to claim 1, wherein the proportion of component (B2), selected from the group consisting of E-glass fibres, A-glass fibres, C-glass fibres, D-glass fibres, basalt fibres, as well as compounds thereof, each with circular or non-circular transverse surface, is in the range of 0-10% by weight, or in the range of 0-5% by weight.

26. The thermoplastic moulding compound according to claim 1, wherein there is only component (B1) and not (B2) or (B3) present.

27. The thermoplastic moulding compound according to claim 1, wherein the glass fibres of component (B1) are high-strength glass fibres based on the ternary system silicon dioxide-aluminium oxide-magnesium oxide or on the quaternary system silicon dioxide-aluminium oxide-magnesium oxide-calcium oxide, wherein they have the following composition: 60-67%, by weight silicon dioxide (SiO₂); 20-28%, by weight aluminium oxide (Al₂O₃); 7-12%, by weight magnesium oxide (MgO); 0-9%, by weight calcium oxide (CaO); and 0-1.5%, by weight other oxides, namely zirconium dioxide (ZrO₂), boric oxide (B₂O₃), titanium dioxide (TiO₂), or lithium oxide (Li₂O), or a combination of these oxides.

28. The thermoplastic moulding compound according to claim 9, wherein the glass fibres of component (B1) are high-strength glass fibres with the following composition: 62-66% by weight silicon dioxide (SiO₂), 22-27% by weight aluminium oxide (Al₂O₃), 8-12% by weight magnesium oxide (MgO), 0-5% by weight calcium oxide (CaO) and 0-1% by weight other oxides, namely zirconium dioxide (ZrO₂), boric oxide (B₂O₃), titanium dioxide (TiO₂), lithium oxide (Li₂O), or a combination of these oxides.

29. The thermoplastic moulding compound according to claim 1, wherein the glass fibres of component (B1) have a tensile strength of at least 4000 MPa, as well as an ultimate elongation of at least 5.0%, and a tensile modulus of more than 80 GPa.

30. The thermoplastic moulding compound according to claim 1, wherein the glass fibres of component (B1) and/or (B2) are present in the form of short fibres, in the form of cut glass with a length of 0.2-20 mm, or in the form of rovings.

31. The thermoplastic moulding compound according to claim 1, wherein component (C) is a particulate filler material selected from the group consisting of: talc, mica, silicates, quartz, wollastonite, kaolin, silicic acids, magnesium carbonate, magnesium hydroxide, chalk, ground or cut calcium carbonate, lime, feldspar, barium sulphate, zinc oxide, zinc sulphide, titanium dioxide, ferric oxide, ferric manganese oxide, copper ferric spinel, magnesium aluminium oxide, copper-chromium-manganese-compound oxides, copper-manganese-iron-compound oxides, copper chromium oxide, zinc-ferric oxide, cobalt chromium oxide, cobalt-aluminium oxide, magnesium aluminium oxide, titanium-zinc-rutile, nickel-antimony-titanate, chromium-antimony-titanate, permanent magnetic or magnetisable metals or alloys, concave silicate filler material, aluminium oxide, boron nitride, boron carbide, aluminium nitride, calcium fluoride, and compounds and/or surface-treated forms thereof.

32. The thermoplastic moulding compound according to claim 11, wherein the particles of component (C) have an average particle size (D₅₀) of 0.3-10 μm, and/or an aspect ratio of at most 5, or is mainly formed by such particles.

33. The thermoplastic moulding compound according to claim 11, wherein component (C) has absorption coefficients different from zero for UV, VIS or IR radiation.

34. The thermoplastic moulding compound according to claim 11, wherein component (C) has absorption coefficients different from zero for UV, VIS or IR laser radiation, with an absorption capacity in visible and/or infrared radiation spectrum with an absorption coefficient of at least 0.2

35. The thermoplastic moulding compound according to claim 1, wherein component (A1) is a homo-polyamide and/or co-polyamide made of aliphatic, cycloaliphatic and/or aromatic monomers, namely of a compound made of a partially crystalline, aliphatic polyamide (A1_{—}1) and/or a partial aromatic polyamide (A1_{—}2), and/or an amorphous polyamide (A1_{—}3), whereby the polyamides in component (A1) are selected from the following group: polyamide 46, polyamide 6, polyamide 66, polyamide 11, polyamide 12, polyamide 1212, polyamide 1010, polyamide 1012, polyamide 1112, polyamide 610, polyamide 612, polyamide 69, polyamide 810, MACM9, MACM10, MACM11, MACM12, MACM13, MACM14, MACM16, MACM18, PACM9, PACM10, PACM11, PACM12, PACM13, PACM14, PACM16, PACM18 or co-polyamides, such as MACMI/12, MACMT/12, 6I/6T/MACMI/MACMT/12, 3-6T, 6I/MACMI/MACMT, 6I/PACMI/PACMT, 6I/6T/MACMI, MACMI/MACM36, 12/PACMI, 12/MACMT, 6/PACMT, 6/IPDT, MACM10/PACM10, MACM12/PACM12, MXD6, MXD10, MXDI/MXD6, 6T/6I, 6T/66, 6T/10T, 6T/12, 11/10T, 12/10T, 10T/1010, 10T/1012, PA10T/6T, PA6T/10I/10T, PA6T/6I/6, PA10I/10T, 9MT, 12T, as well as mixtures and blends thereof.

36. The thermoplastic moulding compound according to claim 1, wherein component (A) or component (A2) is selected such that the thermoplastic component (A) consists of polyamide (A1) or a mixture of polyamides, with the proviso that up to 40% can be replaced by a thermoplastic synthetic (A2) that is not polyamide-based and is selected from the group consisting of: MBS and/or core-sheath impact resistance modifiers, on the basis of methacrylate butadiene styrene, SEBS co-polymers, and/or wherein the component (D) is selected from a group consisting of: bonding agents, flame retardants containing or free of halogen, stabilisers, antioxidant agents, antioxidants, antiozonants, light stabilisers, UV stabilisers, UV absorbers, UV blockers, inorganic heat stabilisers, based on copper halide and/or alkali halides, organic heat stabilisers, conductivity additives, carbon black, optical lighteners, processing aids, nucleation agents, crystallisation catalysts, crystallisation inhibitor, flow-inducing agents, lubricants, mould release agents, softening agent, pigments, colours, tracers and compounds thereof.

37. The thermoplastic moulding compound according to claim 1, wherein the thermoplastic component (A) consists of polyamide (A1) or a mixture of polyamides, with the proviso that 3-20% can be replaced by a thermoplastic synthetic (A2) that is not polyamide-based.

38. The thermoplastic moulding compound according to claim 1, wherein the thermoplastic component (A) consists of polyamide (A1) or a mixture of polyamides, with the proviso that 5-20% can be replaced by a thermoplastic synthetic (A2) that is not polyamide-based.

39. Device with electric conductive paths on the basis of a moulding compound according to claim 1.
